(19) United States
(12) Patent Application Publication
(10) Pub. No.: US 2025/0057295 A1
(43) Pub. Date: Feb. 20, 2025

(54) HEATER ASSEMBLY FOR A HAND-HELD APPLIANCE

(71) Applicant: Dyson Technology Limited, Malmesbury, Wiltshire (GB)

(72) Inventor: Andrew Christopher FORBES, Newport (GB)

(21) Appl. No.: 18/720,094

(22) PCT Filed: Dec. 15, 2022
(86) PCT No.: PCT/GB2022/053240

§ 371 Date: Jun. 14, 2024

(30) Foreign Application Priority Data
Dec. 16, 2021 (GB) 2118278.7

(51) Int. Cl. A45D 1/04; A45D 1/00; A45D 20/12; H05B 3/26

(52) U.S. Cl. CPC A45D 1/04; A45D 20/12; H05B 3/265; A45D 2001/004

(57) ABSTRACT

Provided is a heater assembly for a hand-held appliance. The assembly includes a ceramic heater substrate having a heated region that includes heater elements for converting electrical energy to heat, and an unheated region adjacent to the heated region. The assembly includes a heat sink for dissipating heat from the heater elements, where the heat sink extends from the heated region of the ceramic heater substrate. The assembly includes electronic control devices for controlling electrical energy supply to the heater elements, and which are mounted at the unheated region of the ceramic heater device. The assembly includes heat dissipation means to dissipate heat from the heater elements to maintain the unheated region at a lower temperature than the heated region.

### TECHNICAL FIELD

The invention relates to a heater assembly and, in particular, to a heater assembly for a hand-held appliance such as a hair care product in which one or more electronic control devices are mounted to a ceramic heater substrate of the heater assembly.

### BACKGROUND

Hand-held appliances such as hair care appliances are typically provided with a heater to heat air flowing through the appliance. Many such appliances are in the form of a pistol grip with a handle including switches and a body or housing that houses components including the heater and a fan unit and motor for creating airflow through the appliance towards an outlet of the housing. Other such appliances such as hot styling appliances may be in the form of a tubular housing. It is therefore generally the case that heat is blown out of an end of a tubular housing and to either hold onto an end of that housing or be provided with a handle that is orthogonal to the housing.

The heaters of such hand-held appliances are known to use so-called ‘bare wire’ technology. More recently, however, high temperature, co-fired ceramic (HTCC) heaters have been developed for incorporation into hand-heled appliances. HTCC heaters are beneficial compared to bare wire heaters in that they are more compact and power dense, thereby enabling the size of such hand-held appliances to be reduced. Also, HTCC heaters allow for the air temperature at the exit of the appliance to be controlled with lower conductive and radiative emissions. This is because multiple heater elements or traces each with different resistances may be embedded in the ceramic substrate of the heater. In contrast, such control using bare wire technology may necessitate additional heater elements, resulting in larger, bulkier heaters. Furthermore, HTCC heaters may make use of an embedded RTD (Resistance Temperature Detector) sensor to achieve thermal safety of the heater, which again may contribute to an HTCC heater being more compact that a bare wire heater, as a bare wire heater may use separate thermal fuses or similar for this purpose.

Despite these benefits, issues still remain with the design and integration of HTCC heaters in hand-held appliances. For instance, the printed circuit board (PCB) that includes the electronic control devices for controlling power supply to the HTCC heater is comparable or larger in size than the heater assembly, adding bulk to the appliance. The electronic control devices may include TRIAC (triode for alternating current) components. To keep the TRIAC components sufficiently cool, the PCB needs to be positioned in the airflow created by the electric motor and fan unit of the appliance, thereby introducing integration constraints. Also, in order to control each of the multiple heater elements or traces of the HTCC heater independently, multiple high voltage/high current connections (wires) must be included between the PCB and heater assembly. In addition to adding further bulk to the appliance and restricting the position and orientation of the PCB relative to the heater, an undesirable mechanical and thermal connection is created between the PCB and the heater assembly. Furthermore, a connector region of the heater assembly where the connections from the PCB are attached to the heater assembly has the same or similar operating temperature as the heater elements (typically greater than 300 degrees Celsius), which means that the connectors need to be attached using a brazing method, thereby limiting the choice of materials and attachment methods.

It is against this background to which the present invention is set.

### SUMMARY OF THE INVENTION

According to an aspect of the invention there is provided a heater assembly. The heater assembly comprises a ceramic heater substrate having a first or heated region that includes one or more heater elements for converting electrical energy to heat, and a second or unheated region adjacent to the heated region. The heater assembly comprises a heat sink for dissipating heat from the heater elements. The heat sink extends from the heated region of the ceramic heater substrate. The heater assembly comprises one or more electronic control devices for controlling electrical energy supply to the one or more heater elements. The one or more electronic control devices are mounted at the unheated region of the ceramic heater device. The heater assembly comprises heat dissipation means arranged to dissipate heat from the heater elements to maintain the unheated region at a lower temperature than the heated region.

The heat dissipation means may be located at an intersection of the heated region and the unheated region of the ceramic heater substrate.

The heat dissipation means may comprise a further heat sink.

The further heat sink may extend from the unheated region of the ceramic heater substrate.

The further heat sink may comprise a plurality of fins extending from one or both sides of the ceramic heater substrate.

The heat sink may comprise a plurality of fins extending from one or both sides of the ceramic heater substrate.

The fins of the further heat sink may be an extension of the fins of the heat sink.

The heat dissipation means may comprise a thermal link to the unheated region that is arranged to conduct heat away from the unheated region.

The heat dissipation means may comprise means arranged to reduce a thermal conductivity of the unheated region relative to a thermal conductivity of the heated region.

The means arranged to reduce the thermal conductivity may comprise a dopant that dopes at least part of the unheated region of the ceramic heater substrate.

The heat dissipation means may comprise a thermal mass arranged to reduce a transfer of heat from the heated region to the unheated region.

According to another aspect of the invention there is provided a hand-held appliance comprising a heater assembly as described above.

The hand-held appliance may comprise: an electric motor; a fan unit; and, a housing arranged to house the heater assembly, the electric motor, and the fan unit. The fan unit may be driven by the electric motor to create an airflow past the heater assembly to an outlet of the housing.

The heater assembly may be arranged in the housing such that the unheated region is proximal to the fan unit and the heated region is distal to the fan unit.

The hand-held appliance may comprise a printed circuit board including one or more electronic components of the hand-held appliance. The printed circuit board may be separate from the one or more electronic control devices of the heater assembly.

The printed circuit board may be positioned out of a path of the airflow past the heater assembly.

The hand-held appliance may comprise low voltage/current wires connecting the printed circuit board with the electronic control devices of the heater assembly.

The hand-held appliance may comprise a single pair of live/neutral wires arranged to connect the electronic control devices of the heater assembly to a mains electricity source.

The hand-held appliance may comprise standard multiplex connectors arranged to connect the wires to the heater assembly.

The hand-held appliance may be a hair care appliance. Optionally, the hair care appliance is a hair styler and/or hair dryer.

### BRIEF DESCRIPTION OF THE DRAWINGS

Examples of the invention will now be described with reference to the accompanying drawings, in which:

FIG. 1 schematically illustrates a heater assembly in accordance with an example of the invention;

FIG. 2 shows a schematic plan view of the heater assembly of FIG. 1;

FIG. 3 shows a plot of the temperature against distance from a heated region of variants of the heater assembly of FIG. 1;

FIG. 4 schematically illustrates a heater assembly in a different example from FIG. 1;

FIG. 5 schematically illustrates a heater assembly in another different example from FIG. 1;

FIG. 6 schematically illustrates a heater assembly in a further different example from FIG. 1;

FIGS. 7(a) and 7(b) show illustrative plots of temperature over time in heat soak conditions of respective heater assemblies, where FIG. 7(a) shows a plot for a heater assembly that does not include heat dissipation means in accordance with examples of the invention, and FIG. 7(b) shows a plot for a heater assembly that does include heat dissipation means in accordance with examples of the invention;

FIG. 8 schematically illustrates a hair care appliance including the heater assembly of one of FIGS. 1, 4, 5, and 6;

FIG. 9 shows a sectional view of the hair care appliance of FIG. 8;

FIG. 10 schematically illustrates a sectional view of another hair care appliance including the heater assembly of one of FIGS. 1, 4, 5, and 6;

FIG. 11 schematically illustrates a heater assembly in a similar example to FIG. 4; and

FIG. 12 is a cross section through the heater assembly of FIG. 11 along line A-A.

### DETAILED DESCRIPTION

The invention advantageously provides a co-fired ceramic heater assembly that incorporates one or more electronic control devices (for controlling the heater elements/traces of the assembly) as part of the heater assembly. This is achieved by creating a region of the heater assembly for incorporating the electronic control devices that is cooler than the rest of the heater (or a region that includes the heater elements). In particular, this ‘cool’ or ‘unheated’ region is created via the provision of heat dissipation means for dissipating heat generated by the heater away from the cool region. The heat dissipation means may take a number of different forms, as discussed in greater detail below.

A number of advantages are associated with such an arrangement in which the electronic control devices are mounted to the heater instead of a printed circuit board (PCB) that includes various electronic components of an appliance in which the heater assembly is incorporated. For instance, the creation of the cool region of the heater assembly means that standard fabrication and connection techniques typically used for a PCB may be used for the wiring connections to the heater assembly (rather than more specialist techniques such as brazing for withstanding the typically higher temperatures of a heater). The electronic connections to the heater assembly are therefore greatly simplified. In particular, multiplex connectors of the type typically used on PCBs may be used for the connections.

Also, in the heater assembly of the invention only low voltage/current signal wires are needed to control the heater elements. This is in contrast to prior arrangements, in which multiple high voltage/high current signal wires are needed between the PCB and heater to control each heater element independently. Furthermore, in the heater assembly of the invention only a single pair of live/neutral wires is needed on the heater assembly, and does not need to be routed via the PCB of the appliance in which the heater assembly is incorporated. As the number of connectors is minimised in the invention, then there is a space saving allowing for a more compact design of the appliance incorporating the heater assembly.

With the power electronics being mounted on the heater assembly rather than a PCB, the PCB does not need to be cooled to guard against the electronic control devices from overheating. Therefore, in examples in which the heater assembly is part of a hand-held appliance that generates an airflow, the PCB does not need to be positioned in the airflow to achieve a cooling effect (which is in contrast to known arrangements), thereby increasing the design flexibility of the appliance. These and further advantages will become apparent in the below description of specific examples in accordance with the invention.

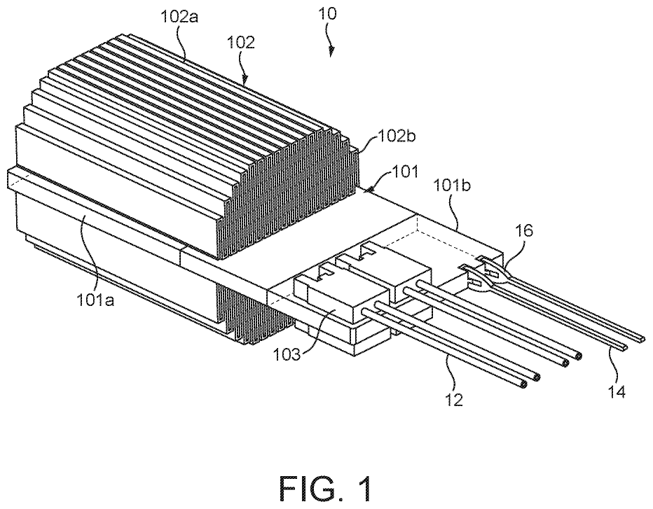

FIG. 1 illustrates a heater assembly 10 in accordance with an example of the invention. The heater assembly 10 includes a ceramic heater substrate 101 including embedded heater elements or traces (not shown in FIG. 1), and includes a heat sink 102 for dissipating heat from the heater 101, as will now be discussed in greater detail.

The heater substrate 101 may be formed from a flat ceramic plate-such as aluminium nitride, aluminium oxide, or silicon nitride-which has heater elements in the form of one or more conductive tracks that are typically screen printed onto the flat ceramic plate when the substrate is in its green state, i.e. prior to the plate being fired or sintered. The heater substrate 101 may be planar and generally of cuboidal shape. The substrate 101 may be formed by stacking a number of layers of type cast ceramic material until the required thickness is achieved and then laminating the stack layers. The lamination process may involve vacuum sealing the stack in a plastic bag and hydrostatically pressing the stack to form the substrate 101.

Heat is dissipated from the heater elements via the heat sink 102, which in the described example is in the form of a plurality of fins that extend out or away from the substrate 101 to facilitate heat transfer to a fluid (e.g. air) that flows past the heater assembly 10 in use. The heat sink 102 may be made from a conductive material such as aluminium, copper, or titanium.

Once the heater elements have been screen printed onto the flat ceramic plate, it can either be covered by an insulating material such as a glaze or further layers of tape cast ceramic material may be stacked over the heater elements to embed the heater elements within the ceramic.

The substrate 101 and heat sink 102 may be manufactured in different ways. In one example, the heater substrate 101 is fired and then sintered fins 102 can be bonded to the sintered heater substrate 101 using a bonding paste such as a glass bonding paste. In another example, the fins 102 may be attached to the flat ceramic plate 101 in the green state and then they may be co-fired as a single unit, which may provide a stronger joint. Methods that involve using bonding paste, glue, thermal paste, glaze, etc. for attaching the heat sink to the ceramic plate may have temperature limitations of approximately 2-300 degrees Celsius. For higher operating temperatures, brazing of the heat sink onto the ceramic plate may be used. This may involve metallising the ceramic plate to enable the metal heat sink to be bonded to the ceramic. In turn, this can involve coating the outer surface of the ceramic plate with a metallisation paste that may typically include the ceramic material used to form the ceramic plate, and a refractory material such as tungsten, plus binders and fillers. In particular, brazing the heat sink onto the ceramic plate may involve melting an intermediate layer of metal—which melts at a lower temperature than the heat sink and ceramic plate—and re-solidifying it in-situ to form a bond between the (metal) heat sink and the ceramic plate.

The substrate 101 and heat sink 102 may be formed in two parts that are subsequently bonded together. In particular, the two parts may be a mirror image of each other, each including part of the substrate and fins on one side of the substrate part, where the two substrate parts are then bonded together.

In the described example, the substrate 101 includes four heater elements embedded within, although it will be understood that any suitable number of heater elements may be used. A different number of the heater elements may be operated in different territories, depending on voltage requirements of the territories. For instance, each of the four heater elements may be operated in parallel in territories where a lower voltage is required. In contrast, only two of the heater elements may be used in higher-voltage territories.

Each of the heater elements needs to be electrically connected to a power source. In known arrangements, power electronics for providing the power source may be part of a printed circuit board (PCB) such that connections between the PCB and heater elements are needed. Indeed, the greater the number of heater elements embedded in the substrate, the greater the number of connections are needed for independent control of the heater elements. In particular, the power electronics include electronic control devices, e.g. in the form of TRIACs, to control the mains voltage. In the described arrangement in which four heater traces or elements are embedded in the heater substrate, four TRIACs are provided for individual power control. These electronic control devices are relatively bulky. A relatively large amount of space would therefore be consumed by the devices on the PCB in known arrangements. Also in known arrangements, as the TRIACs dissipate heat they require cooling, e.g. by positioning the PCB in an air stream of a product in which the heater assembly is incorporated. The connectors needed to connect the wiring to the devices and to the heater elements are also relatively bulky (that is, the components on both the PCB and on the heater assembly). Furthermore, as the region of the heater assembly where the connectors are disposed has the same (or similar) operating temperature as the heater, then in known arrangements it may be that the only way to join the connectors is by brazing (at over 500 degrees Celsius, for instance), which adds to the complexity of the manufacturing process.

As outlined above, the present invention provides for mounting the electronic control devices on the heater assembly and, in particular, on the heater substrate. Referring back to FIG. 1, it may be seen that in the described example the heater substrate 101 extends beyond the heat sink 102. That is, part of the substrate 101 has the heat sink 102 extending therefrom, and another part of the substrate 101 does not have the heat sink 102 extending therefrom. In prior arrangements, it may be that substantially all (or a substantial majority) of the substrate would have a heat sink extending therefrom, with a relatively small region for allowing connectors (to the power electronics, etc.) to be joined to the heater assembly. The substrate 101 of the illustrated example may therefore be regarded as a substrate that is manufactured with an extended length relative to some prior arrangements.

The extended part of the substrate 101 is for mounting the electronic control devices 103 (e.g. TRIACs) for controlling electrical energy supply to the heater elements embedded in the substrate 101. The (single piece) substrate 101 may therefore be considered as having a first region 101a, where the heat sink 102 extends from the substrate 101, and a second region 101b adjacent to the first region 101a, for mounting the TRIACs 103. The TRIACs 103 may be standard components (such as a die), e.g. 1-2 mm², such as about 1.5 mm². The TRIACs 103 may be housed or encapsulated in a plastic (or other insulative) housing or enclosure (such as a DPAK or Decawatt Package), e.g. about 10 mm². There is an internal connection between the TRIACs 103 and the heater elements embedded in the substrate 101.

The heater elements may be embedded in the first (heated) region 101a of the substrate 101. During operation, heat from the heating elements will transfer along the ceramic substrate 101 to the second (unheated) region 101b, thereby transferring heat to the TRIACs 103 mounted at the second region 101b. This causes an issue as the heater assembly may operate at a relatively high temperature, e.g. 300 degrees Celsius or above. However, in order for the TRIACs 103 to remain operable the steady state temperature must be within TRIAC operating limits and solder degrading. Also, transient heat soak temperatures must be below TRIAC storage limits and solder degrading. Even if the heater assembly 10 is placed in an airstream of a product, the cooling effect of the airstream is not sufficient to keep the TRIACs 103 within these limits when they are mounted on the heater substrate 101.

As such, it is necessary to create a ‘cooler’ region of the substrate 101 where the TRIACs 103 are mounted, that remains at a lower temperature than a region of the substrate 101 where the heater elements are embedded that dissipate heat to the heat sink 102. That is, the second region 101b of the substrate 101 needs to operate at a lower temperature than the first region 101a. For instance, while the first region 101a may operate at temperatures of 300 degrees Celsius or above, the second region 101b may need to be kept at a steady state temperature of below 100 degrees Celsius in order to stay within operating limits of the TRIACs.

The cooler, second region 101b is achieved by providing the heater assembly 10 with heat dissipation means that dissipates heat from the heater elements to maintain the region 101b where the TRIACs 103 are mounted at a lower temperature than the region 101a where the heater elements are embedded. The heat dissipation means may take different forms and may be located at different positions relative to the other components of the heater assembly 10, and some examples of heat dissipation means are outlined below.

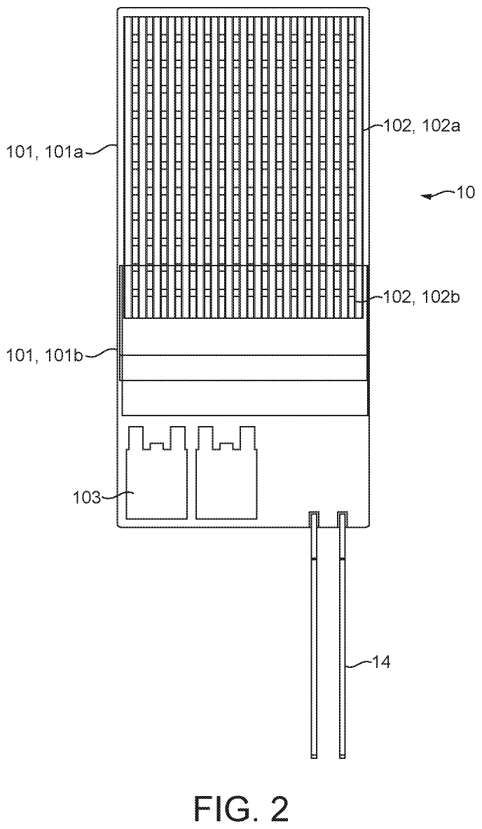

With continuing reference to FIG. 1, and additional reference to FIG. 2, the heat dissipation means in the described example is in the form of a further or additional heat sink. In particular, FIGS. 1 and 2 illustrate that while the heat sink 102 extends from the first, heated region 101a, the heat sink 102 is also in the second, unheated region 101b such that the heat sink extends from the unheated region. That part of the heat sink 102 that extends from the unheated region 101b may be referred to as the further heat sink 102b, with the part extending from the heated region 101a as the first heat sink 102a. Forming the heat sink 102 to include the further heat sink 102b for dissipating heat from the heater elements away from the TRIACs 103 may be beneficial in reducing the number of components to be manufactured.

When the heater elements embedded in the first region 101a of the ceramic substrate 101 generate heat, the first heat sink 102a attached at the heated region 101a dissipates heat away from the heater elements to the surroundings. As mentioned above, the heat generated by the heater elements also transfers or transports along the ceramic substrate 101 towards the unheated region 101b. The further heat sink 102b therefore acts to absorb the conducted heat to limit the amount of heat that is transferred further along the ceramic substrate 101 to where the TRIACs 103 are mounted, thereby keeping the region where the TRIACs 103 are mounted at a temperature less than the heated region 101a. The further heat sink 102b may be regarded as being positioned between the heated region 101a and the position at which the TRIACs 103 are mounted to the substrate 101. In this case, the further heat sink 102b is positioned at an intersection between the heated and unheated regions 101a, 101b.

Referring again to FIG. 1, there is provided electrical wiring connections for powering the heater assembly. In particular, there is provided voltage/current signal wires 12 to the electronic control devices 103. Specifically, these may be ‘low voltage/current’ connections 12. Whereas previous arrangements may have needed six ‘high voltage/current’connections between the heater assembly and the TRIACs on a PCB (for individual control of the heater elements), as the TRIACs 103 are part of the heater assembly 10 in the invention then only relatively low voltage/current wires are needed between a PCB and the TRIACs 103 of the heating assembly 10 to power the TRIACs to control the heating elements. By low voltage may be meant wiring designed to carry voltage less than a certain value, e.g. less than 50 volts. In the described example, the low voltage/current connections 12 may carry a voltage of significantly less than this, e.g. 5 volts. In contrast, by high voltage may be meant a mains voltage, e.g. 120 volts or 240 volts. The wiring of the described example may be beneficial for packaging/compactness reasons.

FIG. 1 also illustrates the provision of a single pair of live/neutral wires 14 for connecting the heater assembly 10 to the mains power. In previous arrangements, several pairs of live/neutral wires, or at least several live wires, would be needed for powering individual heater elements of a heater assembly. In contrast, as the TRIACs 103 of the described example are incorporated into the heater assembly 10, then the single pair of live/neutral wires 14 can power the TRIACs 103, which can then provide for individual control of the heater elements. Furthermore, unlike in previous arrangements, the single pair of live/neutral wires 14 do not need to be routed via a PCB between a mains source and the heater assembly 10 as the individual power control of the heater elements is provided by the TRIACs 103 on the heater assembly 10. This further simplifies a PCB of an appliance in which the heater assembly is integrated, in particular such that the PCB may be used exclusively for mounting low-voltage components of the appliance.

The connectors 16 for joining the wiring to the heating assembly 10 may use standard joining techniques, such as those typically used for connections on a PCB. For instance, the connectors 16 may be in the form of standard multiplex connectors used on PCBs. This is in contrast to previous arrangements, where a more complex joining method such as brazing needs to be used to join the connections to a heater assembly. In the previous arrangements, the location of the heater assembly at which the connections are joined will typically have an operating temperature similar to that of the heater. As such, the connections need to be joined in an appropriate manner to withstand these thermal conditions. In FIG. 1, it may be seen that the connectors are located at the second, unheated region 101b of the heater substrate 101. As such, the connectors 16 do not need to withstand the same higher temperatures as previous arrangements, hence why a more standard joining solution is possible.

FIG. 2 also indicates a number of different lengths that the further heat sink may be in different examples, namely, 0 mm, 5 mm, 10 mm and 15 mm, where the further heat sink starts at the intersection between the first and second regions 101a, 101b. Note that the 0 mm case refers to the case in which no further heat sink is included.

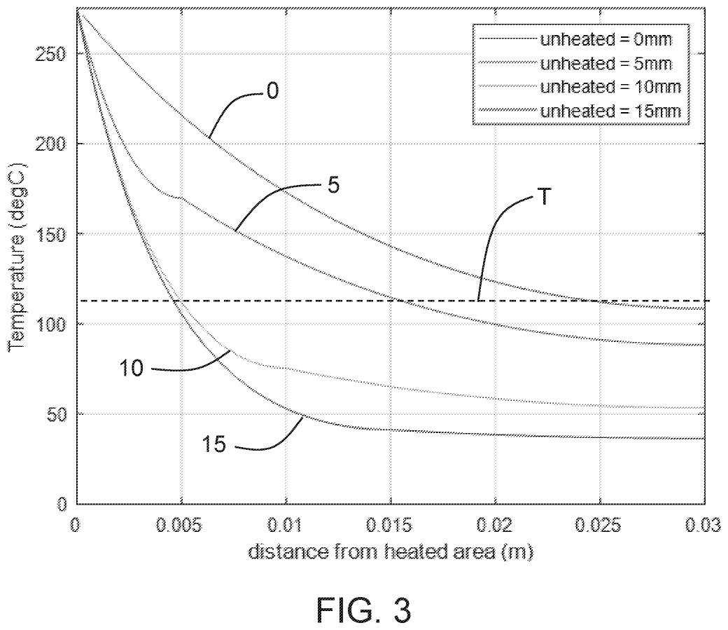

FIG. 3 shows a plot of how the temperature of the unheated region 101b varies with distance from the heated region 101a for the further heat sinks of different lengths. FIG. 3 also indicates a target operating temperature T of the TRIACs 103, where the temperature of the TRIACs 103 should be kept no greater than this value (in this example, about 110 degrees Celsius). It may be seen that the greater the size (length) of the further heat sink, the less the distance from the heated region 101a needs to be to achieve a substrate temperature less than the target operating temperature, i.e. a position suitable for mounting the TRIACs 103.

In the described example, the second region 101b is considered to include the region of the substrate 101 from where the further heat sink 102b extends. In different examples, the region of the substrate 101 from where the further heat sink 102b extends may be regarded as a discrete region between the first region 101a (where the heater elements are embedded) and the second region 101b (where the TRIACs are mounted, beyond the further heat sink 102b).

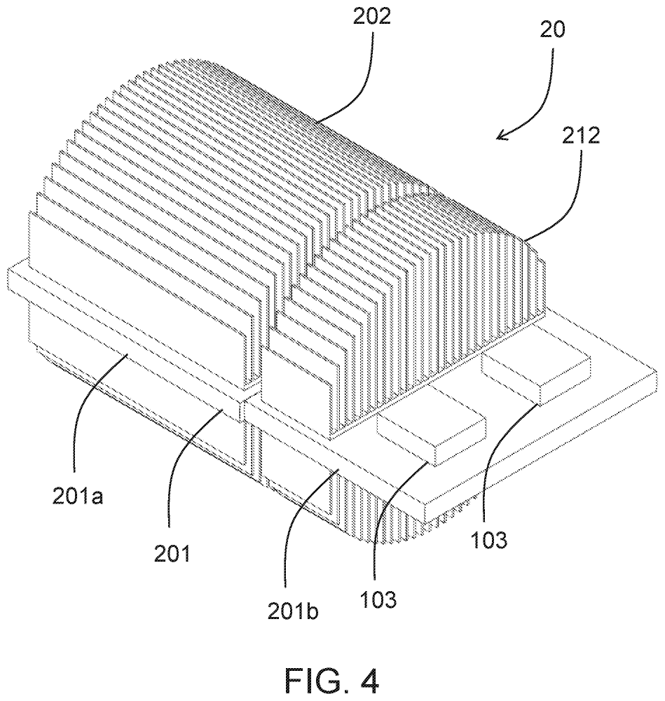

It will be understood that the further heat sink may be formed separately from, and/or be distant from, the heat sink mounted at the heated region 101a. In some cases, this may provide a greater dissipation effect to keep the region housing the TRIACs 103 cooler than the heated region. FIG. 4 schematically illustrates an example of a heater assembly 20 in which a ceramic heater substrate 201 has a first (heated) region 201a with a heat sink 202 extending therefrom, and a second (unheated) region 201b with a further heat sink 212 extending therefrom. The heat sink 202 and further heat sink 212 are separate components and spaced apart from each other along the substrate 201. The spacing between the heat sink 202 and further heat sink 212 may be set to any suitable length. This arrangement may be referred to as an air heat sink arrangement.

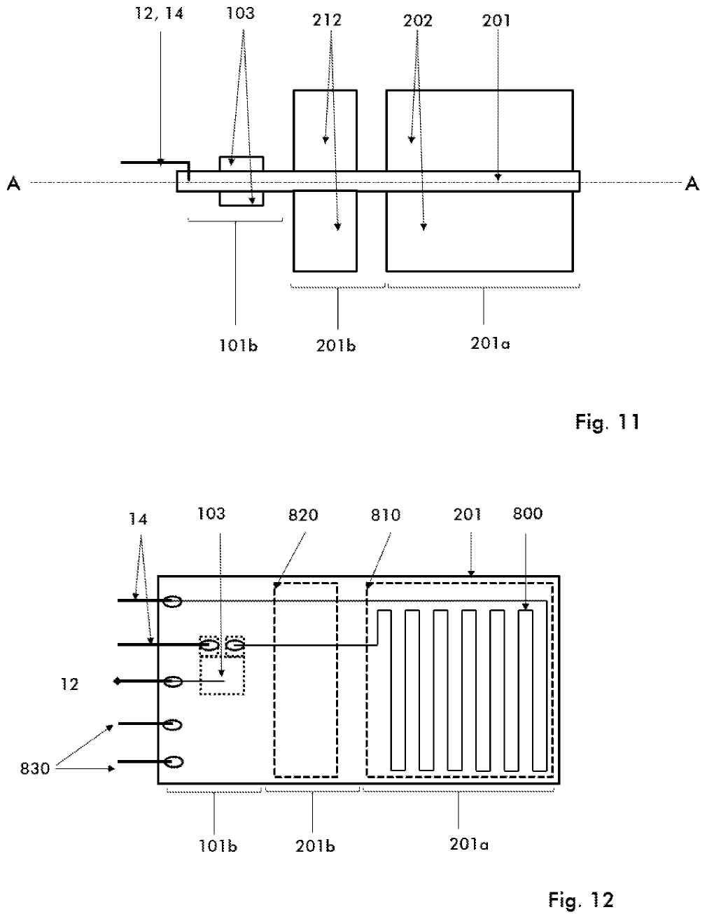

Referring now to FIGS. 11 and 12, they show a side view and a cross sectional view respectively through a heater assembly that is similar in structure to that shown in FIG. 4. The ceramic substrate 201 has three main regions firstly, a heated region 201a which contains the heater trace 800 and a hot region heat sink 202 which dissipates heat from the heater trace when the heater is turned on. A second region which is a cooled region 201b having a cool region heatsink 212 which is outside of the heater trace 800 and therefore the heater region 201a. A third region 101b where electronics 103 are mounted. This third region 101b is also an unheated region and is spaced from the heater region 201a by the cooled region 210b. At the distal end of the third region 101b from the heated region 201a are electrical connectors comprising a single pair of live/neutral wires 14 for connecting the heater assembly to the mains power, ‘low voltage/current’ connections 12 for the mounted electronics 103 and a pair of wires for the RTD 830.

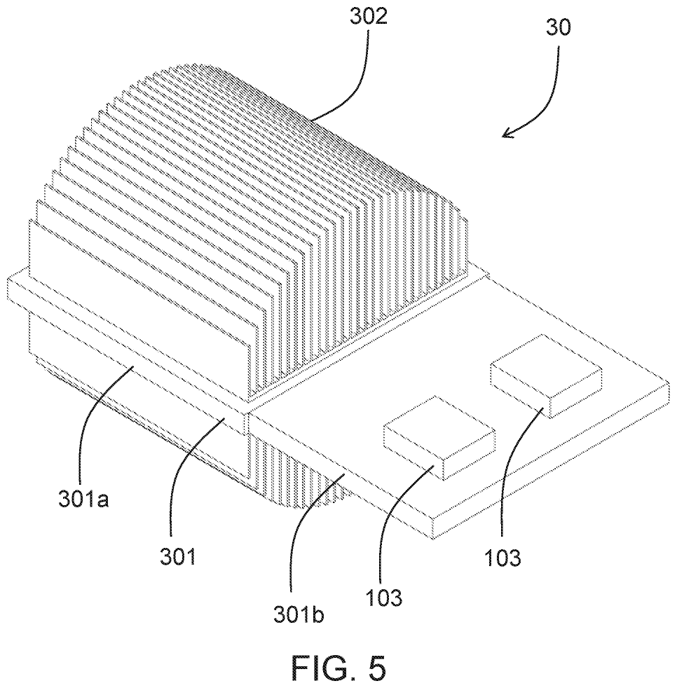

FIG. 5 schematically illustrates another example of a heater assembly 30 with electronic control devices 103 mounted thereon in which a different type of heat dissipation means is used to create a cooler region where the electronic control devices are located. Similarly to the above-described examples, the heater assembly 30 has a ceramic heater substrate 301 that includes a first (heated) region 301a, with a heat sink 302 extending therefrom, and a second (unheated) region 301b where the electronic control devices 103 are mounted. In particular, in the example of FIG. 5 the heat dissipation means is in the form of means to reduce or suppress a thermal conductivity of the second (unheated) region 301b relative to a thermal conductivity of the first (heated) region 301a. Specifically, in the example of FIG. 5 at least part of the second (unheated) region 301b of the substrate 301 is doped with a suitable dopant (not shown in the figure) in order to reduce the thermal conductivity of this region. Any suitable dopant may be used for this purpose, e.g. scandium.

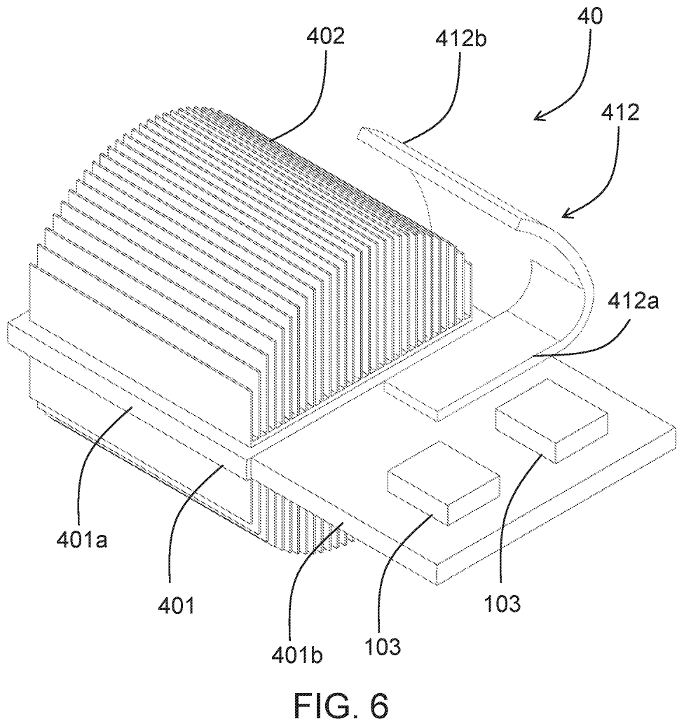

FIG. 6 schematically illustrates a further example of a heater assembly 40 that has a ceramic heater substrate 401 that includes a first (heated) region 401a, with a heat sink 402 extending therefrom, and a second (unheated) region 401b where the electronic control devices 103 are mounted. In particular, in the example of FIG. 6 the heat dissipation means is in the form of a thermal link 412 to the second region 401b that conducts heat away from the second region 401b—and, in particular, the electronic control devices 103—during heat soak of the heater assembly 40. During heat soak, heat that is conducted through the substrate 401 from the first, heated region 401a towards the second, unheated region 401b is dissipated via the thermal link 412 to limit the level of heat reaching the electronic control devices 103.

The thermal link 412 may be in any suitable form. In the illustrated example, the thermal link 412 has a first part 412a that joins to the second region 401b of the substrate 401, and a second part 412b—joined to, or formed integrally with, the first part 412a—that extends away from the substrate 401. The first part 401a is disposed between the first region 401a of the substrate 401 and the electronic control devices 103. The second part 412b is of greater width than the first part 412a in the illustrated example, so as to maximise the surface area, and so the heat dissipation capabilities, of the thermal link 412. The width of the first part 412a is limited by the dimensions of the second region 401b of the substrate 401. The width of the second part 412b extends away from the first part 412a in a direction opposite/away from the electronic control devices 103, in particular towards the first region 401a and heat sink 402, so as to direct heat away from the electronic control devices 103. In the illustrated example the second part 412b is of generally curved shape, which may be beneficial to maximise surface area of the heat sink while adhering to space constraints to allow for integration of the heater assembly 40 into an appliance. If the heater assembly is to be positioned in an air flow of an appliance, then the thermal link 412 may further assist in transferring heat to the air flowing past (in addition to the heat sink 402). The thermal link may be of any suitable material, e.g. metal.

The thermal link 412 may be regarded as a (further) heat sink that dissipates heat away from the ceramic substrate to the surroundings. Whereas the further heat sinks 102b, 212 in the above-described examples may take a similar form to the heat sinks 102a, 202 extending from the heated region of the substrate, the thermal link 412 is illustrated as taking a different form from the heat sink 402.

In a further example, the heat dissipation means may include a thermal mass arranged to reduce a transfer of heat from the first, heated region of the ceramic heater substrate to the second, heated region where the electronic control devices are mounted. In particular, a sacrificial thermal mass may be positioned at the unheated region of the ceramic substrate between the heated region of the substrate and the electronic control devices.

The thermal mass may absorb heat conducted along the ceramic substrate from the heated region to the unheated region so as to limit the amount of heat conducted to the electronic control devices. The thermal mass may be formed from any suitable material, e.g. steel.

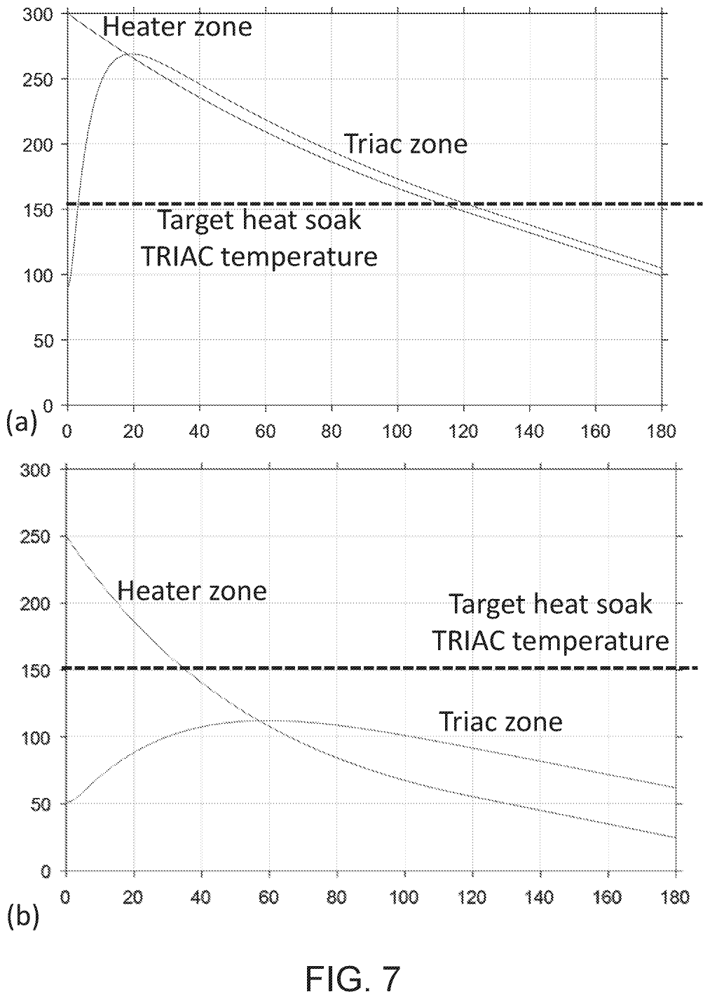

FIGS. 7(a) and 7(b) show illustrative plots of temperature over time in heat soak conditions of a heater assembly that includes a first, heated region and a second, unheated region, as described in the examples above. That is, FIGS. 7(a) and 7(b) show plots of when the appliance or product into which the heater assembly is integrated is switched off and the heat stored in the ceramic heater ‘soaks’ out through the heater enclosure towards the TRIAC zone, i.e. the zone where the electronic control devices (TRIACs) are mounted at the unheated region of the substrate. In particular, FIG. 7(a) illustrates how the temperatures in the first, heated region (heater zone) and in the second, unheated region (TRIAC zone) vary over time when no mitigations for the heat soak conditions are provided to the heater assembly, i.e. when no heat dissipation means (as outlined above) are provided. It may be seen that the TRIAC zone temperature rises to substantially the same temperature as the heater zone (first, heated region)—and, in particular, to above a target heat soak TRIAC temperature (in this example, approximately 155 degrees Celsius)—before the temperature in both zones reduces at substantially the same rate, eventually falling below the target heat soak TRIAC temperature.

In contrast, FIG. 7(b) illustrates how the temperatures in the first, heated region (heater zone) and in the second, unheated region (TRIAC zone) vary over time when a number of mitigations (heat dissipation means) are provided to guard against the heat soak conditions in the TRIAC zone. For instance, these mitigations can include one or more of those outlined in the examples above, such as doping the ceramic of the TRIAC zone to reduce its thermal conductivity, providing a heat leak (thermal link) to the TRIAC zone to intercept the heat soak, providing a sacrificial thermal mass to absorb thermal energy, and reducing the temperature of the heater. In the example illustrated in FIG. 7(b), each of these different types of mitigations are provided. It may be seen that, while the temperature in the TRIAC zone does increase initially, it peaks at a value significantly below the target heat soak TRIAC temperature before starting to decrease. That is, the temperature in the TRIAC zone remains within defined operating limits.

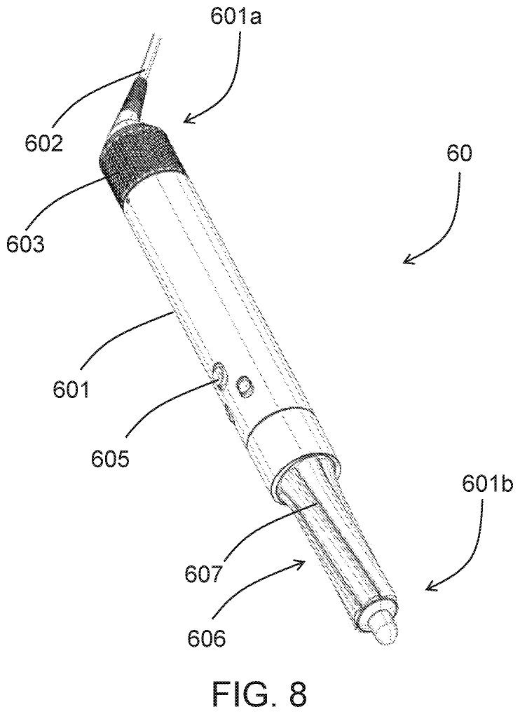

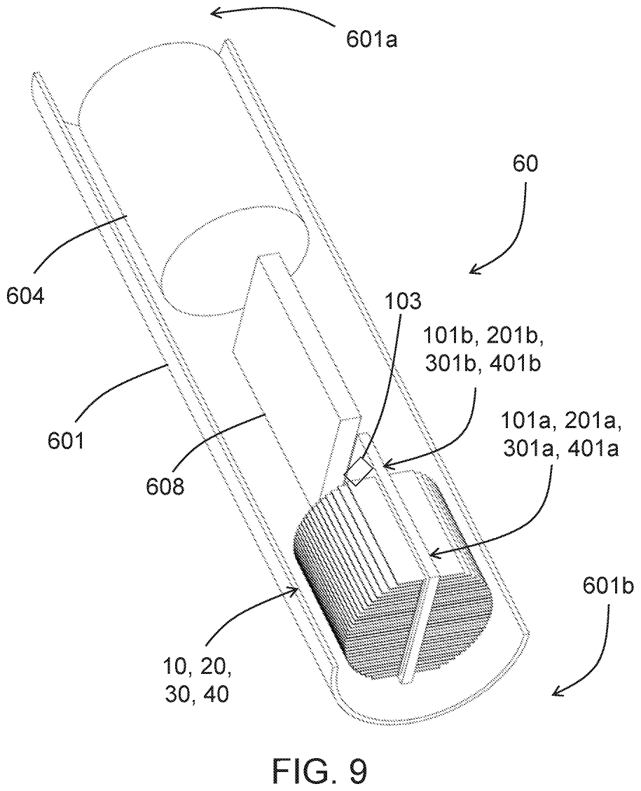

FIG. 8 schematically illustrates an example of an appliance 60 that may incorporate a heater assembly as described in the above, e.g. one of the heater assemblies 10, 20, 30, 40. In particular, the appliance 60 is a hair care appliance in the form of a hair dryer and hair styler, such as an Airwrap™. The hair care appliance 60 includes a generally elongate, cylindrical (tubular) housing body 601. At a first end 601a of the body 601, there is attached a power cable 602 for connecting the appliance 60 to a power source, e.g. a mains socket. At the first end 601a, the body 601 includes a region of air holes 603. With additional reference to FIG. 9, which illustrates a sectional view of the appliance 60, inside the body 601 at the first end 601a is an electric motor that is powered via the power cabling, and a fan unit, driven by the electric motor, that is for drawing air in through the air holes 603 and creating an airflow inside the body 601. The electric motor and fan unit are collectively labelled 604 in FIG. 9.

At a second end 601b of the body 601—opposite the first end 601a—there is provided an attachment or barrel portion 606 onto which one or more hair styling attachments (e.g. a blow-drying nozzle, rounded/flat brushes, curling iron barrels, etc.) may be mounted. The attachment portion 606 is of generally elongate, cylindrical shape and includes a number of (e.g. six) slits or outlets 607 extending along the length of the attachment portion 606 which are equally spaced around the circumference of the attachment portion 606. The outer part of the body 601 includes a number of switches 605 for controlling operation of the appliance 60, e.g. to turn the appliance on/off, change an operation setting, etc.

With continuing reference to FIGS. 8 and 9, inside the body 601 between the first and second ends 601a, 601b there is provided the heater assembly 10, 20, 30, 40. The heater assembly 10, 20, 30, 40 is oriented such that the first (heated) region 101a, 201a, 301a, 401a of the ceramic heater substrate 101, 201, 301, 401 is distal to the first end 601a of the appliance body 601 where the motor and fan unit 604 are located (and proximal to the second end 601b with the attachment portion 606). In turn, the heater assembly 10, 20, 30, 40 is oriented such that the second (unheated) region 101b, 201b, 301b, 401b of the ceramic heater substrate 101, 201, 301, 401 is proximal to the first end 601a of the appliance body 601 where the motor and fan unit 604 are located (and distal to the second end 601b with the attachment portion 606).

During operation of the appliance, the electric motor drives the fan unit to create an airflow that flows down and along the interior of the body 601. As the air flow over and around the heater assembly 10, 20, 30, 40 (in particular, the heat sink), the air is heated. The heated air then flows towards the second 602b end of the body 601 and exits the body 601 via the outlet 607. The particular arrangement of the outlet slits 607 acts to create a vortex, in particular harnessing an aerodynamic effect referred to as the Coanda effect. Specifically, the heated air is curved to attract and wrap hair to the attachment portion 606, in use.

The appliance 60 further includes a PCB 608 for housing electronic components of the appliance 608. As the TRIACs 103 are mounted on the heater assembly 10, 20, 30, 40, then the PCB 608 can be relatively compact and does not necessarily need to be positioned in the airflow along the interior of the body 601 (for a cooling effect). There is therefore greater flexibility in terms of where the PCB 608 may be positioned in the appliance 60, which is beneficial for design and integration reasons. In the described example, the PCB 608 is positioned in the body 601 between the electric motor and the heater assembly 10, 20, 30, 40, in the generated airstream.

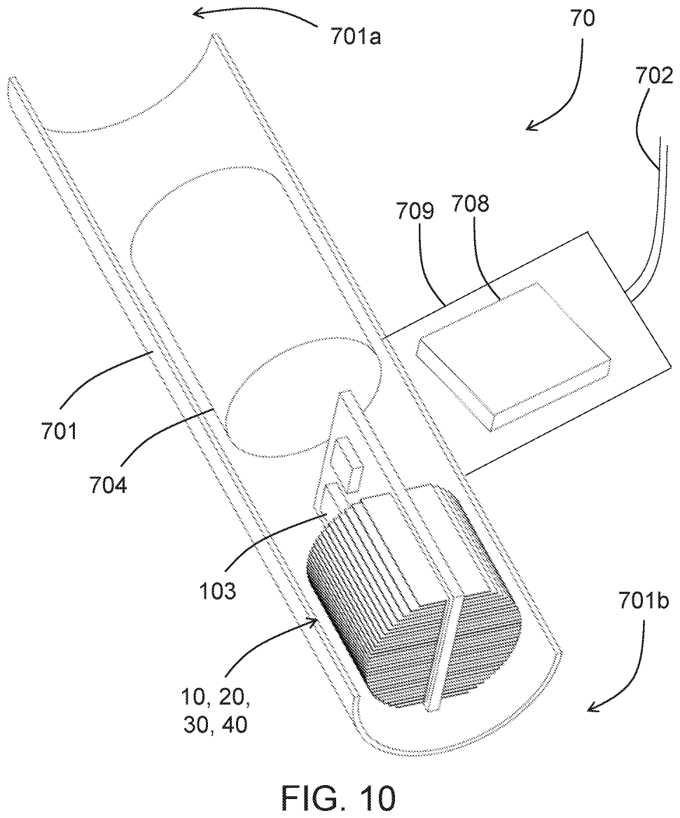

FIG. 10 schematically illustrates a sectional view of another example of an appliance 70 that incorporates the heater assembly 10, 20, 30, 40. Like the appliance 60 illustrated in FIGS. 8 and 9, the appliance 70 is a hair care appliance and includes a housing body 701 that has a fan unit and electric motor 704 at a first end 701a, an attachment or barrel portion (not shown) at a second end 701b, and one of the heater assemblies 10, 20, 30, 40 between the first and second ends 701a, 701b. Unlike the appliance 60 illustrated in FIGS. 8 and 9, the appliance 70 has a handle portion 709 extending down from the body 701. The power cabling 702 is connected to the handle portion 709. Furthermore, the PCB 708 with (low-voltage) power electronics other than the TRIACs 103 is disposed in the handle portion 709 (i.e. out of the airstream created through the body 701). This allows for a more compact housing body 701, and/or greater design freedom to incorporate various of the components into the housing body 701 (e.g. without the cable 702 entering at the first end 701a of the body 701, more space for a filter component or other components may be available).

Many modifications may be made to the examples described herein without departing from the scope of the appended claims.

Although the above examples describe different forms that the heat dissipation means may take, it will be understood that different types of heat dissipation means may be used in combination to create the cool region of the ceramic substrate housing the electronic control devices, e.g. two or more from a further heat sink, a thermal mass, a thermal link, a doped region of the substrate, etc., and/or indeed two or more of the same type of heat dissipation means.

The above describes an example in which the heater assembly is incorporated into an appliance in the form of a hair dryer and hair styler such as an Airwrap™. However, it will be understood that the heater assembly could be incorporated into different hair care appliances, such as a (dedicated) hair dryer or a hot styler/curling product. It will also be understood that the heater assembly may be incorporated into other appliances in which heated air is directed through a housing to an outlet, such as a hot air blower.

1. A heater assembly, comprising:
a ceramic heater substrate having a first region that includes one or more heater elements for converting electrical energy to heat, and a second region adjacent to the first region;
a heat sink for dissipating heat from the heater elements, the heat sink extending from the first region of the ceramic heater substrate,
one or more electronic control devices for controlling electrical energy supply to the one or more heater elements, the one or more electronic control devices being mounted at the second region of the ceramic heater device; and,
heat dissipation means arranged to dissipate heat from the heater elements to maintain the second region at a lower temperature than the first region.

2. The heater assembly according to claim 1, wherein the heat dissipation means is located at an intersection of the first region and the second region of the ceramic heater substrate.

3. The heater assembly according to claim 1, wherein the heat dissipation means comprises a further heat sink.

4. The heater assembly according to claim 3, wherein the further heat sink extends from the second region of the ceramic heater substrate.

5. The heater assembly according to claim 3, wherein the further heat sink comprises a plurality of fins extending from one or both sides of the ceramic heater substrate.

6. The heater assembly according to claim 5, wherein the heat sink comprises a plurality of fins extending from one or both sides of the ceramic heater substrate.

7. The heater assembly according to claim 6, wherein the fins of the further heat sink are an extension of the fins of the heat sink.

8. The heater assembly according to claim 1, wherein the heat dissipation means comprises a thermal link to the second region that is arranged to conduct heat away from the second region.

9. The heater assembly according to claim 1, wherein the heat dissipation means comprises means arranged to reduce a thermal conductivity of the second region relative to a thermal conductivity of the first region.

10. The heater assembly according to claim 9, wherein the means arranged to reduce the thermal conductivity comprises a dopant that dopes at least part of the second region of the ceramic heater substrate.

11. The heater assembly according to claim 1, wherein the heat dissipation means comprises a thermal mass arranged to reduce a transfer of heat from the first region to the second region.

12. A hand-held appliance comprising the heater assembly of claim 1.

13. The hand-held appliance according to claim 12, the hand-held appliance comprising:
an electric motor;
a fan unit; and,
a housing arranged to house the heater assembly, the electric motor and the fan unit,
wherein the fan unit is driven by the electric motor to create an airflow past the heater assembly to an outlet of the housing.

14. The hand-held appliance according to claim 13, wherein the heater assembly is arranged in the housing such that the second region is proximal to the fan unit and the first region is distal to the fan unit.

15. The hand-held appliance according to claim 12, the hand-held appliance comprising a printed circuit board including one or more electronic components of the hand-held appliance, the printed circuit board being separate from the one or more electronic control devices of the heater assembly.

16. The hand-held appliance according to claim 15, wherein the printed circuit board is positioned out of a path of the airflow past the heater assembly.

17. The hand-held appliance according to claim 15, comprising low voltage or low current wires connecting the printed circuit board with the electronic control devices of the heater assembly.

18. The hand-held appliance according to any of claim 12, comprising a single pair of live or neutral wires arranged to connect the electronic control devices of the heater assembly to a mains electricity source.

19. The hand-held appliance according to claim 17, comprising standard multiplex connectors arranged to connect the wires to the heater assembly.

20. The hand-held appliance according to claim 12, wherein the hand-held appliance is a hair care appliance; and wherein the hair care appliance is a hair styler and/or hair dryer.
